(19) United States
(12) Patent Application Publication
(10) Pub. No.: US 2018/0275023 A1
(43) Pub. Date: Sep. 27, 2018

(54) METHOD FOR PASSIVE OR ACTIVE SAMPLING OF PARTICLES AND GAS PHASE COMPONENTS IN A FLUID FLOW

(71) Applicant: PROVTAGAREN AB, Hässleholm (SE)

(72) Inventors: Gunnar Skarping, Hässleholm (SE); Marianne Dalene, Hässleholm (SE)

(21) Appl. No.: 15/557,428

(22) PCT Filed: Mar. 11, 2016
(86) PCT No.: PCT/SE2016/050199

§ 371 Date: Sep. 11, 2017

(30) Foreign Application Priority Data
Mar. 12, 2015 (SE) 1550303-0

(51) Int. Cl. G01N 1/22

(52) U.S. Cl. CPC G01N 1/2214

(57) ABSTRACT

A method for passive or active sampling of particles and gas phase components in a fluid flow. A sampling device is provided in the fluid flow, wherein the sampling device comprises an ionization chamber and a detection chamber. A fraction of the particles and the gas phase components in the fluid become ionized and charged when introduced in the ionization chamber. The charged particles and gas phase components are then introduced in the detection chamber, which comprises a positively charged wall surface and a negatively charged wall surface. The positively charged particles and gas phase components are bound to the negatively charged wall surface, and the negatively charged particles and gas phase components are bound to the positively charged wall surface. The amount of particles present in the fluid flow is determined by measuring the current change between the positively charged wall surface and the negatively charged wall surface.

### TECHNICAL FIELD OF THE INVENTION

The present invention relates to a method for passive or active sampling of particles and gas phase components in a fluid flow.

### BACKGROUND

There is a continuous demand for the monitoring of air-borne compounds that may have health effects on exposed individuals. A great interest exists for compounds that have occupational exposure limit values, set by governmental bodies, to ensure that the levels of such compounds are satisfactory low. In many cases it is not known what the air contaminants consist of, and for this reason it is of interest to learn more details about the nature of these “unknown” compounds and to reveal the identity of the most predominate ones. Another field of interest is to study and check the effect of measures with a view to reducing these levels in air, e.g. to check the “true” ventilation efficiency or other measures to control the air levels. Devices for this purpose can also be used for the monitoring of the quality of compressed air and air in respiratory protective devices. Other fields of application for such devices are e.g. the control of different volatile compounds present in food. Such compounds can be used as markers for degradation of certain food components or to monitor raw materials to ensure a satisfactory quality. Such devices may also be used to ensure that other compounds have not contaminated food. In hospitals such devices can be used to check the air levels of e.g. narcosis gases and to ensure that the personnel, patients and others are not exposed to toxic levels. Chemical warfare agents are also compounds that need to be checked for in order to reveal the presence thereof and to ensure that individuals are not exposed.

In environmental analysis there is a need to monitor the quality of air in cities, public places and in the nature or other environments. One purpose is to obtain background data for statistical studies and to check if the levels are below the levels set by national and international bodies. Such devices can also be used to check if the emission of industrial pollutants results in exposure in the nature or in populated areas. The achieved data can have an impact on decisions and interpretation of a certain situation. There is therefore a demand of a satisfactory high quality of the data.

There are many examples of air pollutants that occur in both gas and particle phase. Of special interest are the size fractions that have the ability to reach the lower respiratory tract. There are reasons to believe that the toxi-cology is different depending on not only the chemistry as such but also on the distribution on different target organs in the body of humans. There is a need to know more about the exposure to the respirable particle fraction present in air. In some cases it is also of interest to determine the identity and amount of inhalable particles, i.e. particles having the ability to pass the nose and the mouth when breathing in, and in some cases the identity and amount of particles that can reach the lungs and lower airways, i.e. particles having the ability to pass through the larynx when breathing in.

Numerous devices exist for the monitoring of air-borne compounds and there is a great variety of technology used. In principle, the devices can be grouped in selective and non-selective devices. Non-selective devices give a response for several compounds and do not differentiate between two or several compounds and may also result in false positive results. Such devices are today still used, possibly due to the low cost. In many applications, false positive results can give rise to a high cost for the user, if costly measures are performed from invalid data.

Selective devices give a certain response for a selected compound or a group of compounds. Other present compounds do not interfere with the result. The frequency of false positive results will be much less as compared to non-selective monitoring. The quality of the data obtained is essential. Typical factors that describe the quality of the data are: repeatability, reproducibility, linearity (calibration graph characteristics with intercept and background), detection limit and quantification limit. In addition, knowledge regarding the interference from other compounds is necessary. It needs to be mentioned that a certain compound can influence the result even if the compound does not itself give rise to a response.

Similar techniques for the detection of air-borne compounds involves the use of e.g. photo ionisation detectors (PID, Thermo Scientific, Franklin, Mass., USA), flame ionisation detectors (FID, Thermo Scientific, Franklin, Mass., USA), infrared detectors (IR), portable gas chromatography (GC)-PID (PID Analyzers, Pembroke Mass., USA), portable GC-mass spectrometers (MS, Inficon Inc., New York, USA), GC-DMS ((Differential Mobility Spectrometry), Sionex Inc., Bedford, Mass., USA). All techniques give a response for a certain analyte, but to know the concentration the response needs to be translated into concentration by using information from a more or less sophisticated calibration curve. For many of the above techniques, the response varies with time due to ageing, contamination of the detector (reduces the signal) and other variables.

The GC-DMS technique mentioned above is used in the MicroAnalyser instrument (Sionex Inc., Bedford, Mass., USA). The GC-DMS technique is based on GC separation, with regards to compound volatility, in combination with the separation in a DMS sensor, with regards to other molecular properties such as size shape, charge etc.

There are several drawbacks with the present types of instruments. For PID and FID, identification of the individual chemicals is not possible. PID and FID detectors measure the sum of VOC (Volatile Organic Compounds). Infra-red detectors suffer from problems with inferences. IR detectors are not possible to use when monitoring VOCs at low concentration when other interfering compounds are present.

Polyurethane (PUR) products as air pollutants are of particular interest to monitor and analyze. They frequently occur in industry, in particular in manufacturing and handling polyurethane foam, elastomers, adhesives and lacquers. Polyurethane is produced by the reaction of a bifunctional isocyanate with a polyfunctional alcohol. The satisfactory technical qualities of polyurethane have resulted in a large increase of its use and application fields during the last decades. In connection with thermal decomposition of polyurethanes, however, the formation of isocyanates, aminoisocyanates, anhydrides, and amines might occur, and extremely high contents can be found in air, e.g. when welding automobile sheet steel. Besides the known types of isocyanate, also new types of aliphatic isocyanates have been detected, in connection with e.g. heat treatment of car paint. Most of the isocyanates formed have been found to be represented by so-called low-molecular isocyanates. During short periods of time (peak exposure) particularly high isocyanate contents can be present, as is the case, for instance, when welding. Of all the dangerous substances on the limit value list, isocyanates have the lowest permissible contents. Exposure to this new type of isocyanates was previously unheard of. Isocyanates in both gas and particle phase have been detected in connection with welding, grinding and cutting of painted automobile sheet steel, and particles that can reach the lungs and lower airways in high contents containing isocyanates have been detected. In thermal decomposition products of painted automobile sheet steel, detection has been made of, among other things, methyl isocyanate (MIC), ethyl isocyanate (EIC), propyl isocyanate (PIC), phenyl isocyanate (Phi), 1,6-hexamethylene diisocyanate (HDI), isophorone diisocyanate (IPDI), 2,4- and 2,6-diisocyanate toluene (TDI) and 4,4-methylene diphenyl-diisocyanate (MDI).

In thermal decomposition of phenol/formaldehyde/urea-(FFU)-plastic, isocyanic acid and methyl isocyanate are formed. FFU plastic is used, among other things, in wood glue and as a binder in mineral wool (and bakelite), which is frequently used as insulation for ovens and furnaces in industrial and domestic use. New fields of application in which exposure to isocyanates has been detected are the soldering and processing of printed circuit boards in the electronic industry, the welding, grinding and cutting of painted sheet steel in the automobile industry and the welding of lacquered copper pipes. Isocyanates have a varying degree of toxicity to the organism depending on their chemical and physical form. As a result, the hygienic limit values have been set at an extremely low level in all countries. For the exposed individual, the degree of exposure to isocyanates varies considerably in different operations during a working day and in connection with breakdowns. Thermal decomposition products from PUR constitute a special problem, since new and completely unknown isocyanates are formed, whose toxicity has not yet been analyzed in a satisfactory manner. Furthermore, the increasingly sophisticated measuring methods have revealed exposure to isocyanates in an increasing number of operations in industry.

Thus, there are a number of operations in numerous working areas where people are daily exposed to or at risk being exposed to isocyanates at a varying degree. Considering the ominous tendency of isocyanates to cause respiratory diseases and the fact that there are some carcinogenic substances among the thermal decomposition products of polyurethane, e.g. 2,4-diamine toluene (TDA), 4,4-methylenediamine (MDA) and MOCA, it is very important to measure in a reliable, sensitive and rapid manner any presence of isocyanates, but also other decomposition products dangerous to health, in environments where there is such a risk.

There is also a particular interest to monitor and analyze such solid/liquid air pollutants as, bacteria, oil mist components, allergens and fungi gaseous organic compounds to analyze are benzene, inorganic gases, volatile organic compounds, chemical warfare agents, anesthetic agents, isocyanates, isocyanic acid (ICA) methyl-isocyanate (MIC), ethyl isocyanate (EIC), propyl isocyanate (PIC), phenyl isocyanate (Phi), 1,6-hexamethylene diisocyanate (HDI), isophorone diisocyanate (IPDI), 2,4- and 2,6-diisocyanate toluene (TDI) and 4,4-methylene diphenyldiisocyanate (MDI), asbestos, dust and metals.

There is also a need to monitor and analyse certain chemical substances present in liquids, e.g. drinking-water, and flows in connection with purification plants. In such cases the liquid flow is transported through a sampling device in which the chemical to analyze is adhered to a specific reagent immobilized within the sampling device, e.g. in a filter and/or on the inner walls thereof, as well as in clean water, waste water, and food.

A sampling device for analysis of air pollutants, more precisely poluretane products, is disclosed in WO 00/75622, and further developments thereof are disclosed in WO 2007/129965, WO 2011/108981, and in WO 2014/193302. The sampling devices, also called samplers, disclosed in these publications collect the probed chemical in a two-step process. A fluid, i.e. a gas or a liquid, in which the amount of a chemical is to be measured, is pumped through the sampling device using a controlled flow. The chemical substance of interest present in the gas phase of the fluid is collected in an adsorption tube using a reagent coated on the surfaces present inside the tube. The flow of fluid is further pumped from the adsorption tube to and through a filter impregnated with the same reagent. The chemical substance in solid form or adhered to particles in the fluid is collected in the filter. After the measurements have been performed, the sampling device is sealed and is shipped to a laboratory for analysis of the amounts of chemical substance collected during the measurements.

It is known to use zeolites in adsorbent tubes, e.g. up to two long steel pipes, for capturing gas phase analytes in fluid flows, but these are not problems with the absorptive capacity.

It is also known that the inner walls of sampling tubes, also called denuders, of sampling devices may be coated with carbon particles having the ability to collect and absorb gas phase components, e.g. benzene, in the sampled air flow. It is also known to provide one or more different reagents on the surfaces of the carbon particles, said reagents having the ability to specifically react with the gas phase components. Sampling tubes which are completely filled or packed with absorbent particles, e.g. carbon particles, for the above-mentioned purpose are also known, also where the surfaces of the sorbent particles are provided with reagents. In such sampling tubes the gas phase compounds bound to the surfaces of absorbent particles or reacted with the reagents provided on the surfaces of the absorbent particles, are then released for subsequent analysis steps via thermal desorption. The shortcomings and drawbacks with these kinds of known sampling devices are that gas phase compounds are bound to the sorbent, or the reagent provided on the sorbent, with a non-optimal specificity. Up to 90% of the gas phase components in a fluid flow should be captured, but this is not the case with most sampling devices presently used.

There is also an interest in providing a method of determining the identity and content of respirable and/or inhalable particles in a specific fluid flow, in particular a fluid flow comprising oil mist or vapor, in a more accurate way than so far known. Presently used methods for such a particle exposure assessment are not accurate enough for determining the amount and identity of respirable and/or inhalable particles due to the fact that the particle fraction and the gas phase fraction occur in the same air volume as they cannot distinguish between the two fractions. Further, when collecting particles there may be further release of volatile components from the trapped particles and this will result in the underestimating on the total air borne particles. Further, the pressure drop of the denuder sampler is much less as compared to the sampling in packed beds of particles.

Thus, there is need of an improved sampling method and sampling device for determining the identity and the amount of respirable particles in a fluid flow, and for determining the identity and amount of specific hazardous or otherwise undesired substances in a fluid flow.

Sampling involving particles is often related to problems with progressive accumulation of moisture within and/or on the surface of the particles after the sampling moment. Already some hours after a sampling the moisture content of the particles have increased or decreased substantially, e.g. during the transport to analysis site. Thus, weighing of the particles a certain time period after the sampling will give a false analysis result. Calibration is normally required with a view to compensating for the effect of such moisture accumulation.

Passive sampling is a widely used sampling technique which is cost effective and convenient in several aspects. In theory, it has several benefits compared to active sampling, i.e. sampling by use of pumps. Commercial passive samplers are based on the diffusion of gas phase components, but cannot be used for sampling and monitoring of particles in a fluid flow. Thus, there is also a need of a method for passive sampling of particles.

### SUMMARY OF THE INVENTION

An object of the present invention is to overcome the drawbacks and disadvantages discussed above by providing a method for passive or active sampling of particles and gas phase components in a fluid flow.

The above-mentioned and other objects of the invention are achieved by a method for passive or active sampling of particles and gas phase components in a fluid flow during a time period, wherein it comprises the steps of:
a) providing a sampling device in a fluid flow (1) comprising particles and gas phase components, wherein said sampling device comprises an ionization chamber (2) and a detection chamber (3), wherein said detection chamber (3) comprises a positively charged wall surface (4) and a negatively charged wall surface (5),
b) passively or actively introducing the fluid flow (1) into the ionization chamber (2), in which a fraction of the particles and a fraction of the gas phase components become ionized and charged,
c) passively or actively introducing the charged particles and gas phase components in the detection chamber (3), in which they are subjected to an electrical field, wherein the positively charged particles and gas phase components are bound to the negatively charged wall surface (5), and the negatively charged particles and gas phase components are bound to the positively charged wall surface (4), wherein any uncharged particles and any uncharged gas phase components not bound to any of said wall surfaces (4, 5) exit the detection chamber (3), and
d) determination of the amount of particles present in the fluid flow (1) after said time period by measuring the current change between the positively charged wall surface (4) and the negatively charged wall surface (5), wherein said current change is proportional to the amount of particles bound during said time period.

### BRIEF DESCRIPTION OF THE DRAWINGS

FIG. 1 shows schematically a sampling device used in the method according to the present invention.

FIG. 2 shows schematically a sampling device used in the method according to the present invention provided with a particle size pre-selector.

FIG. 3 shows schematically a sampling device used in the method according to the present invention provided with a denuder device.

### DETAILED DESCRIPTION OF THE PRESENT INVENTION AND PREFERRED EMBODIMENTS THEREOF

First, some expressions present in the application text will be defined.

The expression “inhalable” used throughout the application text in connection with particles is intended to mean that the particle has such a size that it can pass the nose and the mouth when breathing in. Per definition, an inhalable particle has a maximum width of 100 μm.

The expression “thoracic and respirable” fractions used throughout the application text, are defined as the fraction of inhaled particles capable of passing beyond the larynx and ciliated airways, respectively, during inhalation.

The expression “respirable” used throughout the application text in connection with particles is intended to mean that the particle has such a size that it has the ability to reach the alveoli in the lungs. Per definition, an inhalable particle has a maximum width of 4 μm.

The expression “organic gas phase components” used throughout the application text is intended to mean organic components present in gaseous form in the gas phase in the original fluid flow to analyze.

The expression “non-organic gas phase components” used throughout the application text is intended to mean non-organic components present in gaseous form in the gas phase in the original fluid flow to analyze.

The expression “gas phase components” used throughout the application text is intended to mean both organic and non-organic components present in gaseous form in the gas phase in the original fluid flow to analyze.

The expression “fluid flow” used throughout the application text is intended to mean a flow of a gas or a liquid, which also may contain components in solid form, e.g. fluidized particles and aerosols. One example of a fluid is an air flow containing small particles having the substances to analyze bound to their surfaces.

The expression “fluid flow direction” used throughout the application text is intended to mean the axial direction in relation to the cross-section of the components of the sampler/adsorption device.

The expression “component” used throughout the application text is intended to mean a chemical compound or substance of any kind which is of interest to sample or analyze.

The expression “one or more reagents” used throughout the application text is intended to mean that more than one type of reagent may be used when more than one type of component in the fluid flow is to be analyzed. In the following, the expressions “reagent” or “reagents” are sometimes used for simplicity reasons, but is nevertheless intended to mean “one or more reagents”, unless otherwise is indicated or appears from the context.

The expression “particles” used throughout the application text is intended to mean solid or liquid components of any form.

The expression “an “aerosol” used throughout the application text is intended to mean a mixture of gas and particles.

The expression “gaseous organic and non-organic components in particles” used throughout the application text is intended to mean organic and non-organic compounds and substances which normally exist in gaseous form but which are bound to the particles present in the original fluid flow to analyze. Said “gaseous organic and non-organic components in particles” may be bound within the particles and/or on the surface thereof. Some of the gas phase organic components in particles and some of the gaseous organic components in the fluid flow may be identical. The same may also apply for the gaseous non-organic components.

The expressions “passive” and “passively introduced” used in connection with the fluid flow throughout the application text is intended to mean that the flow of the fluid through the sampling device takes place by just utilizing diffusion thereof, i.e. without any intervention by any flow inducing device.

The expressions “active” and “actively introduced” used in connection with the fluid flow throughout the application text is intended to mean that the flow of the fluid through the sampling device takes place by use of any kind of flow inducing device, such as a pump.

The present invention will now be disclosed in connection with the Figures.

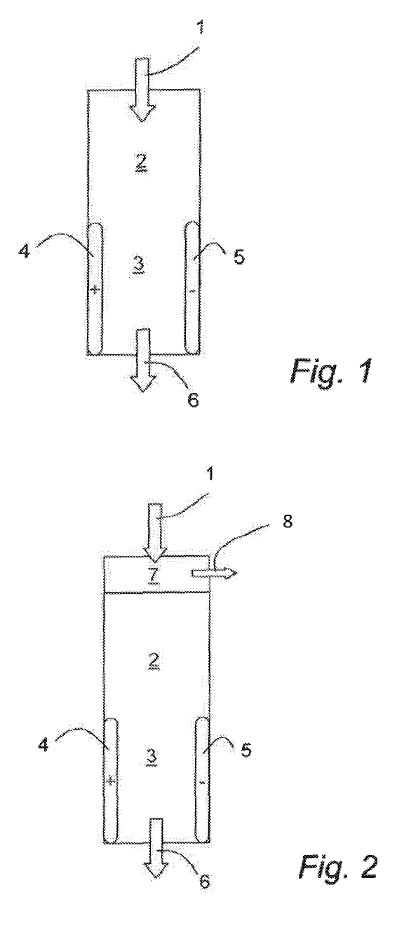

A fluid flow 1 to sample or analyze is passively or actively introduced into a sampling device as shown in FIG. 1. The fluid flow 1 may be any flow which is predominantly gaseous and which contains different kinds of particles and one or more different organic and/or non-organic gas phase components, which may be organic and/or non-organic. Examples of the fluid flow 1 are ordinary air, a pure gas or a mixture of gases, a mist, a fog, a smoke, breathing air work environment air, indoor and outdoor air, and cabin air. The particles may vary substantially as to the form, i.e. be more or less irregularly formed, and may also have sizes that vary substantially. The particles as such may be subject to both analysis as to the identity and as to the amount thereof in the fluid flow 1. The particles may also be provided with one or more different gaseous organic and/or non-organic components, bound inside and/or on the surface the particles. Said gaseous organic and/or non-organic components may be chemically bound or attached in any other way to the particle, e.g. via electrostatic forces. Examples of particles are an organic and/or inorganic compound as such, asbestos, dust, a metal, an anthrax spore, a bacterium, oil mist components, fungi, pollen, mould, an allergen, preferably an animal allergen, a chemical warfare agent, a biological component, a pathogen, and particles derived from a material which is processed by e.g. welding, cutting or grinding. The fluid flow 1 may also contain one or more components which sometimes not are of interest to analyze, such as water. Further, in one embodiment a fluid flow 1 without any particles may be analyzed in view of the amount and identity of only the gas phase components.

The fluid flow 1 passively or actively introduced in the sampling device is first allowed to reach an ionization chamber 2, in which an ionization step is performed. The ionization chamber 2 is typically between 0.1 and 100 mm long in the fluid flow direction, preferably between 5 mm and 20 mm long, and the width or diameter is typically between 0.1 and 70 mm, preferably between 5 and 20 mm. The form of the ionization chamber 2 is not critical, but in one embodiment it is formed like an open-ended cylinder. The ionization chamber 2 can be made of such materials as metal, plastics, and biomaterials. It contains two electrodes, i.e. an anode and a cathode, and these need to be made of conductive materials. During the ionization step a fraction of the particles and the gas phase components present in the fluid flow 1 introduced in the ionization chamber 2 become ionized, preferably the majority thereof, and thereby becomes positively or negatively charged. The particles and gas phase components which become ionized are normally also those which are of interest to analyze.

More precisely, the ionization step performed in the ionization chamber 2 affects the particles and the gas phase components introduced therein in such a way that atoms and molecules in and on the particles and the gas phase components become ionized by losing or acquiring electrons. Any O₂, N₂, and CO₂ present in the fluid flow 1 is not ionized. The ionization may be obtained by use of thermal electron emission or by use of an electron shower, i.e. electric discharge, or by use of beta radiation or photons that directly are ionizing a certain compound or particle, or indirectly first ionizing a certain compound, e.g. an alcohol, that subsequently leaves the charge to a certain compound or a particle. The ionization step takes approximately from 1 microsecond and up to several minutes, preferably 100-1000 microseconds. Other parameters of relevance used during the ionization step are the temperature and the composition of the gas inside the ionization chamber 2, the voltage between the anode and the cathode, and the gas flow velocity.

The negatively charged particles, i.e. particles which have become negatively charged as such and/or which comprise components which have been negatively charged in the interior and/or on the surface of the particles are allowed to pass to a detection chamber 3 connected to the ionization chamber 2 and are collected on the positively charged wall surface 4 in the detection chamber 3. The gas phase components which have been negatively charged are also allowed to pass to the detection chamber 3 and are collected on the positively charged wall surface 4 therein.

The positively charged particles, i.e. particles which have become positively charged as such and/or which comprise components which have been positively charged in the interior and/or on the surface of the particles are allowed to pass to the detection chamber 3 connected to the ionization chamber 2 and are collected on the negatively charged wall surface 5 in the detection chamber 3. The gas phase components which have been positively charged are also allowed to pass to the detection chamber 3 and are collected on the negatively charged wall surface 5 therein.

The positively charged wall surface 4 and the negatively charged wall surface 5 are sometimes collectively called the “wall surfaces 4, 5” in the application text. Some particles may be both positively and negatively charged as such and/or may comprise components which may be both positively and negatively ionized, either in the interior or on the surface thereof, or both. Depending on the relationship between the positive and negative charges, these particles may be collected at different walls. If a particle comprises more negative than positive charges, the particle will be collected at the positively charged wall surface 4, whereas, in the case where a particle comprises more positive than negative charges, the particle will be collected at the negatively charged wall surface 5.

In some cases when the particle is provided with one or more different specific gaseous organic and/or non-organic components, the whole entity of particle and gaseous components will have such an overall charge that the particle is indirectly bound to one of the wall surfaces 4, 5 via said gaseous component.

The wall surfaces 4,5 are in one embodiment large enough for collecting charged particles and charged gas phase components in such a degree that overloading of charged particles and gas phase components on the wall surfaces 4,5 does not takes place, not even during a rather long measurement period of several days. However, this depends on the concentration of particles in the fluid flow.

The charge of the charged wall surfaces 4, 5 acting as electrodes may be generated by applying a voltage (potential). The voltage used to generate the charged wall surfaces 4,5 may be a direct current or an alternating current.

Some components in the fluid flow 1 will not be ionized and do not become charged when entering the ionization chamber 2, such as water, helium, and nitrogen. These components remain neutral and are therefore not collected on the wall surfaces 4, 5 of the detection chamber 3. Instead, these uncharged neutral components pass through the detection chamber 3 and may be released through an exit 6 in the bottom part thereof. However, in the method according to the present invention the amount of uncharged neutral particles exiting the sampling device should be as low as possible, and this may be achieved by choosing the most convenient ionization method for the specific fluid flow 1 to analyze.

The ionization chamber 2 is connected to the detection chamber 3 in such a way that there is a free passage of the fluid flow 1, which has been subjected to ionization, to the detection chamber 3. There is no sharp limit between these chambers, but the ionization chamber 2 can be regarded to be defined by the space in which the ionization source acts, and the detection chamber can be regarded to be defined by the space housing the wall surfaces 4, 5. Both of said walls may be perpendicularly or horizontally arranged in the fluid flow direction, or be arranged in any other convenient direction. In one embodiment the walls are horizontally arranged in the fluid flow direction. The distance between the walls may be between 0.1 and 70 mm, preferably between 5 and 20 mm. The length of the walls is typically between 0.1 and 100 mm, preferably between 5 and 20 mm, and the width of the walls is typically between 0.1 and 70 mm, preferably between 5 and 20 mm. The wall surfaces 4, 5 may be either smooth or rough. The detection chamber 3 can be made of such materials as metal, plastics, and biomaterials. However, the wall surfaces 4, 5 need to be made of conductive materials. Altogether, the whole sampling device may have the size of a lump of sugar.

The charged particles and the charged gas phase components collected on the wall surfaces 4,5 are then subjected to an electrical field applied in the detection chamber 3 with a view to detecting the amount of particles in the fluid flow 1, either momentary or during a certain measurement period. The charged particles and gas phase components when bound to the wall surfaces 4, 5 present in the electrical field creates a current flow between the wall surfaces 4, 5 acting as electrodes and is achieved by applying a voltage between said wall surfaces 4, 5. The potential between the electrodes that forms an electric field may be between 10 and 2000 volts, preferably between 50 and 400 volts. The electrical field may be constant, but may also be varied with respect to its strength and/or frequency. The electrical field may also be applied already in the ionization chamber 2, but in the preferred embodiment the electrical field is located only between the positively and the negatively charged wall surfaces (4, 5) in the detection chamber 3.

The total amount of particles collected in the detection chamber 3 is proportional to a registered current between the wall surfaces 4, 5. To determine the total amount of particles collected in the detection chamber 3 via the registration of the current may alternatively be to weigh the collected particles. More precisely, the current change registration is performed by an electrical amplifier to measure the current in the range of picoamperes to microamperes.

As mentioned above, the current measurement may be performed momentary after a predetermined time period or continuously during a predetermined time period. In one embodiment the registration device may be arranged in such a way that a recognizable signal, e.g. an alarm, such as a sound, a light, a computer signal, is produced or generated when a certain amount of particles which have been collected on the wall surfaces 4, 5 during the predetermined time period reaches or passes a predetermined limit, and/or when the amount of particles collected on the wall surfaces 4, 5 during the predetermined time period is increased compared to the amount obtained during a previous predetermined time period.

This sampling device arrangement may be especially useful in e.g. a factory or a workshop where the method may be used to warn the workers when the amount of particles in the factory or workshop reaches or is at a potentially harmful level. Alternatively, the detected presence of an elevated amount of particles may provide a signal to a ventilation system to increase the ventilation in order to reduce the amount of particles present.

As disclosed above, not only charged particles may be collected on or bound to the wall surfaces 4, 5, but also charged gaseous organic and/or non-organic components, and/or charged organic and/or non-organic gas phase components. Some of these collected charged gaseous components or gas phase components also give rise to charge registrations in addition to those obtained from the registrated charged particles during the current change measurement. This may give rise to a background current. Thus, the charge registrations in view of the particles added with said background current gives a registered total current.

When the contribution of the charged gaseous and/or gas phase components to the total charge registration has been determined, the contribution of charged particles to the registered total current may be calculated and the correct value of particles is obtained.

Some larger particles in the fluid flow 1 may have more than one charge. E.g., particles comprising substances which are easily ionized will have more charges than a particle of the same size comprising substances which are not as easily ionized. This may give rise to more than one registered charge for each particle, and this creates an incorrect result as to the total number of particles. This is however taken into account when calibrating the device. Another method is accomplished by switching off the current and then turning it on again, wherein the cloud of charged ions in the ionization chamber 2 or the detection chamber 3 becomes larger and gives a higher signal. Another way to increase the accuracy is to pulse the current/voltage to be square-waved.

While the fluid flow 1 in the embodiments disclosed above are passively introduced into the sampling device, the particle-containing fluid flow 1 is in one embodiment actively introduced in the sampling device by e.g. using a pump. This is an example of active sampling. In that embodiment the particles in the fluid flow 1 may have a predetermined maximum size or a predetermined size interval, which has been obtained by passage of the fluid flow 1 to be analyzed through one or more particle size pre-selectors 7 arranged before the ionization chamber 2. The pre-selector(s) 7 may be arranged inside or outside the sampling device. The pre-selector 7 can only be used for un-charged particles in the fluid flow 1 and is therefore never arranged after the ionization chamber 2 in the fluid flow direction. In FIG. 2 a sampling device provided with one particle size pre-selector 7 is shown schematically, wherein said size pre-selector is located between the inlet of the fluid flow 1 and the ionization chamber 2. The particle fraction separated from the particle size pre-selector 7 as an exit flow 8 may be subjected to a further analysis in view of the particle amount, e.g. in one or more further different particle size fractions by use of one or more further particle size preselectors 7 having different cut-off values and each coupled to a separate sampling device like the one used in the method according to the present invention.

Thus, several particle size pre-selectors 7 may be arranged in a series, wherein each one separates out a certain particle size fraction which may be introduced into a sampling device as a fluid flow 1 used in the method according to the present invention. Thus, several sampling devices, each one analysing a certain particle size fraction, may be used at the same time and be connected to such particle size pre-selectors 7 coupled in a series. Such a system coupled in a series requires one or more pumps. After a measurement period, the result in view of the total amount of particles in each sampling device in the series may be added together with a view to obtaining the total amount of particles in the original fluid flow 1.

Such particle size pre-selectors 7 may be of interest to use due to the fact that the size distribution of the particles in a fluid flow may be of high importance to determine. This information is highly useful when assessing the health threat the particles pose to humans, since it is well known that the particle size influences how far down in the respiratory tract the particles will reach when inhaled. It is also of interest to more exactly determine the identity and amount of particles which belong to the respirable fraction, thoracic fraction, and inhalable fraction, respectively, in a fluid flow.

The particle size pre-selector 7 may be any kind of conventional device having the ability to separate different size fractions of particles with the basis of a pre-determined cut-off value. One example is a pre-selector called a virtual impactor.

According to one embodiment, the method further comprises the step of providing one or more reagents (not shown in the Figs.), also called derivatisation reagents, having the ability to react with said particles, gas phase components, and gaseous components present within and/or on the surface of said reagents are said gaseous components not released from the particles in connection with the ionization and/or collection of the particles in the detection chamber 3. The reasons for using this embodiment are to stabilise collected reactive chemical or biological compounds.

The reagent may be added already to the fluid flow 1 entering the sampling device, directly to the ionization chamber 2, and/or directly to the detection chamber 3. Thus, the reagent may be added to the fluid flow 1 before, during, and/or after it is subjected to the ionization step. In the detection chamber 3 the reagent may be freely present in the space thereof and/or be bound/adhered to at least one of the charged wall surfaces 4, 5.

The nature of the reagent depends on the specific component which is to be detected or identified, and if some specific hazardous components are suspected to be present in a fluid flow, a set of reagents each reacting specifically with at least one of said hazardous components may be provided in the sampling device. One reagent may react with a specific gas phase compound and/or with a gaseous component bound to a particle and/or to a particle as such before or within the ionization chamber 2, in the space of the detection chamber 3, or on at least one of the wall surfaces 4, 5 when the reagent is bound or adhered thereto.

When the reagent reacts specifically with specific compound and/or with a component bound to a particle and/or to a particle as such, a reaction product is formed. In the subsequent work-up and/or analysis steps for the determination of the identity of the gas phase components, and/or the gaseous components bound to the particles and/or of the particles as such, the reaction product is analysed. In several types of fluid flows some components are present that requires a reagent to be able to be analysed, while some components may be analysed without the need of a reagent. Such a reaction product may be formed in the space of the ionization chamber 2 and/or in the space of the detection chamber 3, and when it has been charged it will be collected on any one of the wall surfaces 4, 5. In some cases the reagent reacts with the specific component before ionization has taken place, and in such cases the reaction product is then ionized, charged and collected on the wall surface 4, 5. When such a reaction product is ionized, it may vary substantially as to which part of the reaction product molecule that is ionized.

In the embodiment when the reagent is initially bound or adhered to at least one of the wall surfaces 4, 5, the reaction product is formed at the wall surface in question. A reagent initially bound/adhered to the wall surfaces 4, 5 may bind a particle to the wall surface via a reaction with a gaseous component bound within or on the surface of the particle or with the particle itself. The location of the reagent in the sampling device depends on the specific components to detect, the nature of the fluid flow, the volatility and the steam pressure of the reagent used, the temperature, and the time.

The reagent should not be added in such a small amount that not all of the specific compound to analyse is reacted and forms a detectable reaction product. On the other hand, the amount of reagent should not be that excessive that it overloads the interior of the sampling device, e.g. the wall surfaces 4, 5. When present already in the incoming fluid flow 1, the concentration of the reagent depends on the component(s) to detect and the nature of the fluid flow, but is typically 1 to 1000 ppm. In the case where the reagent is present on the wall surfaces of the chamber, the concentration of the reagent also depends on the component(s) to detect and the nature of the fluid flow, but is typically 1 to 1000 ppb.

The reagent may be in solid, liquid or gaseous form depending on nature of the compound to be analysed. When present in liquid form it may be viscous. When initially present on the wall surfaces 4, 5, the reagent is bound to the wall surface via a covalent bond or via electrostatic forces, is dissolved in a solution, or is ion-paired. The reagent bound to the wall surfaces 4, 5 is stable and may be present therein up to 24 months when the sampling device not is used.

A specific example of a reagent is a secondary amine for gas phase isocyanates and particle borne isocyanates; a hydrazine compound for aldehydes and ketones; and an acid for stabilization of biological compounds.

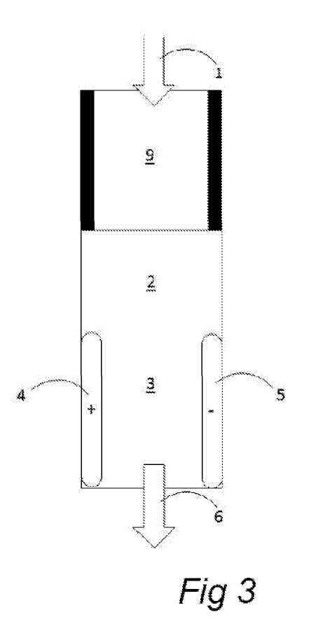

In one embodiment of the present invention the gas phase components in the fluid flow 1 are collected before the fluid flow 1 reaches the ionization chamber 2. FIG. 3 shows such an embodiment, wherein a sampling device is provided with a denuder device 9, in which said gas phase components are collected.

The denuder device 9 may be any kind of conventional denuder or gas filter-like device having the ability to bind specific gas phase components, both organic and/or non-organic. The particles in the fluid flow 1 are not collected in the denuder device 9 and are instead transported to the ionization chamber 2. The denuder device 9 may be prepared in such a way that all of the gas phase components in the fluid flow 1 are collected on the surfaces therein, or in such a way that only specific gas phase compounds are selectively collected therein. In such a way, particles and gas phase compounds in a fluid flow may be analysed separately without any risk for intervening measurement results. Some gas phase compounds are not collected in the denuder device 9, e.g. when the compounds are hydrophilic and the denuder device 9 has a hydrophobic surface, but are nevertheless ionized and bound to the wall surfaces 4, 5.

It also is of interest to determine the identity and to make a quantitative estimation of the particles and the gas phase components which are collected on the wall surfaces 4, 5 as well as the gas phase components collected in any denuder device 9.

The identity may be determined by use of a conventional subsequent work-up process and/or analysis, which is performed automatically in situ and/or in a laboratory. The reason is to find out if the particles as such are hazardous with respect to their chemical nature and if any hazardous gaseous chemical components are bound to the particles.

For this purpose, the particles bound to the wall surfaces 4, 5 of the detection chamber 3 may be released therefrom by thermal release or chemical extraction, i.e. be processed. Then the particles, processed or not, are introduced in the conventional analysis equipment used. In one useful embodiment the analysis is performed by use of gas chromatography and mass spectroscopy. The analysis may also be performed by ultra violet, infrared, gravimetric, and colorimetric determination. The identity of both the particles and the chemical or biological components among the gas phase components and the gaseous components released from within or the surface of the particles may be determined via adequate analytical techniques.

Also the gas phase components of the fluid flow 1 which have been collected in the denuder device 9, either as such or as a reaction product after reaction with a specific reagent introduced in the denuder 9 in the sampling device, e.g. any one of the reagents disclosed in more detail below, may be analysed as to the identity in the same way as the particles, optionally after a processing step, e.g. thermal release or chemical extraction. In such a way, the identity of said charged gas phase components and/or said reaction product may be determined, preferably by use of gas chromatography and mass spectroscopy. In the same analysis also the concentration of the specific gas phase component expressed as amount per time unit may be determined. If the fluid flow passing the sampling device is passive, in-exact results as to the component concentration may be obtained. More exact concentration results are obtained if the measurement is performed with a defined active fluid flow, e.g. induced by a pump.

Suitable flow rates for active sampling are in the range of 1 mL per minute to 5 000 mL per minute, preferably 200 mL per minute. As disclosed above, the amount (in g/m³) of particles present in a fluid flow may be determined by the method according to the present invention.

In one embodiment the detection chamber 3 is detached from the sampling device and is transported as such to the work-up and/or analysis site before the release step is performed.

Alternatively, if only the identity of a potentially hazardous solid particle component and gas phase component in the fluid flow 1, and/or of a gaseous component bound within and/or on the surface of a particle, is of interest to determine, these components may be determined in situ when still present in the detection chamber 3. This can be accomplished by addition of specific markers or reagents having the ability to emit or generate any kind of recognizable signal verifying the presence of the component in question.

Examples of markers and detection methods are reagents that form derivatives that give rise to fluorescence when exposed to e.g. UV light. Examples of signals are alarm signals based on sound, light, fluorescence, reflectance, and absorption.

Also the neutral particles passing the detection chamber 3, and which optionally may be collected in a filter arranged in the exit 6 of the sampling device, may be subjected to the above-mentioned analysis as to the particle identity. This also applies for any gas phase components which not have been charged due to any reason, and also for any gaseous components which due to any reason have been released from the particles in the sampling device and which not have been charged. Thus, with a view to obtaining a complete picture of the gaseous components present in a fluid flow, the particles and components exiting the detection chamber 3 through the exit 6 should also be analysed. This analysis result should be added to the result obtained for the particles and gas phase components released from the detection chamber 3. For the complete picture, also the particles and components leaving any present particle size pre-selector 7 via the exit 8 should be analysed in the corresponding way and the results also be added to the result obtained for the particles and components released from the detection chamber 3.

As stated above, the particles to analyse may be an organic and/or inorganic compound as such, asbestos, dust, a metal, an anthrax spore, a bacterium, oil mist components, fungi, pollen, mould, an allergen, preferably an animal allergen, a chemical warfare agent, a biological component, a pathogen, and particles derived from a material which is processed by e.g. welding, cutting or grinding.

Hazardous chemical components which may be bound to particles and which may be of interest to analyse may be of both organic and inorganic origin.

Examples of such components may be chosen from the group consisting of isocyanates, such as aromatic isocyanates, small aliphatic isocyanates like butylisocyanate (BIC), propylisocyanate (PIC), iso-propyl-isocyanate (i-PIC), ethylisocyanate (EIC), methylisocyanate (MIC) and isocyanic acid (ICA.), but also aminoisocyanates, and isothiocyanates.

Further examples are ammonia (NH₃), amines: [dimethylamine (DMA) n-butylamine (n-BA), methylene dianiline (MDA), p-phenylene diamine (PPD), 2,4 and 2,6-toluene diamine (TDA), trimethylamine (TMA)]; diisocyanates: cyclohexyl diisocyanate (CHDI), hexamethylene diisocyanate (HDI ), dicyclohexyl metan diisocyanate (HMDI), IEM, isophorone diisocyanate (IPDI), 4,4′-methylene diphenylisocyanate (MDI), naphtyldiisocyanate (NDI), paraphenylene diisocyanate (PPDI), 2,4 and 2,6-toluene diisocyanate (TDI), trimethylhexamethylene diisocyanate (TMDI), trimethyl xylene diisocyanate (TMXDI), xylenediisocyanate (XDI); hydrazines: monomethylhydrazine(MMH), hydrazine(N₂H₄,) 1,1 dimethylhydrazine (DMH)

Other examples of substances or compounds are hydrides: arsine (AsH₃), diborane (B₂H₆), disilane (Si₂H₆), germane (GeH₄), hydrogen selenide (H₂Se), phosphine (PH₃), silane (SiH₄), stibine (SbH₃), tert-butylarsine (TBA), tert-butylphosphine (TBP)], hydrogen cyanide (HCN), hydrogen sulfide (H₂S), mineral acids: [hydrogen bromide (HBr), hydrogen chloride (HCl), hydrogen flouride (HF), hydrogen Iodide (HI), nitric acid (HNO₃), sulfuric acid (H₂SO₄)], oxidants: [bromine (Br₂), chlorine (Cl₂)-II, chlorine dioxide (ClO₂), hydrogen peroxide (H₂O₂), nitrogen dioxide (NO₂), ozone (O₃)], phosgene (COCl₂), sulfur dioxide (SO₂).

The method according to the present invention may be performed anywhere, such as in a factory, workshop or in a home, e.g. in a passive particle sampling device. The method may be performed with a sampling device which is installed at the location in which the presence of certain airborne particles or components present on and/or within airborne particles in the fluid flow is to be monitored.

The advantages with the method for passive or active sampling of particles according to the present invention are that it does not involve the use of heavy and inconvenient pump systems, except in the case of the presence of a pre-selectror device, it does not have energy power supply system problems, it does not require supervision, it is noiseless, it is not flammable, it does not represent an explosion hazard, it eliminates the problems with moist accumalation in the particles, and it can be performed by everybody everywhere to a very low cost. Sampling can be performed during a very long time, more precisely up to several days.

Other objectives, features and advantages of the present invention will appear from the following detailed disclosure, from the attached claims, as well as from the drawings. It is noted that the invention relates to all possible combinations of features.

While the invention has been described with reference to a number of embodiments, it will be understood by those skilled in the art that various changes may be made and equivalents may be substituted for elements thereof without departing from the scope of the present invention. In addition many modifications may be made to adapt the teachings of the invention to a particular situation or material without departing from the essential scope of the invention. Therefore, it is intended that the invention not be limited to the particular embodiments disclosed as the best mode contemplated for carrying out this invention, but that the invention will include all embodiments falling within the scope of the appended claims.

1. A method for passive or active sampling of particles and gas phase components in a fluid flow during a time period, wherein the method comprises the steps of:
a) providing a sampling device in a fluid flow comprising particles and gas phase components, wherein said sampling device comprises an ionization chamber and a detection chamber, wherein said detection chamber comprises a positively charged wall surface and a negatively charged wall surface,
b) passively or actively introducing the fluid flow into the ionization chamber, in which a fraction of the particles and a fraction of the gas phase components become ionized and charged,
c) passively or actively introducing the charged particles and gas phase components in the detection chamber, in which they are subjected to an electrical field, wherein the positively charged particles and gas phase components are bound to the negatively charged wall surface, and the negatively charged particles and gas phase components are bound to the positively charged wall surface, wherein any uncharged particles and any uncharged gas phase components not bound to any of said wall surfaces exit the detection chamber, and
d) determination of the amount of particles present in the fluid flow after said time period by measuring the current change between the positively charged wall surface and the negatively charged wall surface, wherein said current change is proportional to the amount of particles bound during said time period.

2. The method according to claim 1, wherein the identity of the particles bound to the wall surfaces, the identity and amount of specific gaseous components present within and/or on the surface of said bound, and the identity and amount of specific gas phase components bound to the wall surfaces during said time period is determined by releasing said particles and said specific gas phase components from the wall surfaces, wherein the released particles and gas phase components then are subjected to a conventional analysis for the determination of identity and amount.

3. The method according to claim 1, wherein said analysis is gas or liquid chromatography, mass spectroscopy, ultra violet, infra-red, gravimetric, and colorimetric determination.

4. The method according to claim 1, wherein the said particles and said specific gas phase components are released from the wall surfaces thermally and/or by chemical extraction.

5. The method according to claim 1, wherein a calibrated value obtained in view of the amount of uncharged particles exiting the sampling device during said time period is added to the amount of particles obtained by the current change measurement.

6. The method according to claim 1, wherein the identity of the particles bound to the wall surfaces, the identity and amount of specific gaseous components present within and/or on the surface of said bound, and the identity and amount of specific gas phase components bound to the wall surfaces during said time period is determined when still present in the detection chamber by adding one or more markers specific for said bound particles, gaseous components, and gas phase components and having the ability to emit or generate a recognizable signal verifying the presence of said particles and gaseous and gas phase components.

7. The method according to claim 6, wherein a recognizable signal is emitted or generated when particles having a size less than a predetermined value or having a size within a specific interval is bound to any one of said charged walls.

8. The method according to claim 7, wherein the recognizable signal is a sound, light, fluorescence, reflectance, and/or absorption.

9. The method according to claim 1, wherein one or more reagents specifically reactive with the components to be determined are provided in the ionization chamber and/or in the detection chamber, wherein the reaction products from the reaction between the reagent and said components are subjected to the analysis in view of determining the identity and amount thereof.

10. The method according to claim 9, wherein said one or more reagents are provided on the positively charged wall surface and/or the negatively charged wall surface.

11. The method according to claim 1, wherein the particles in the fluid flow introduced into the sampling device have a predetermined maximum size or a predetermined size interval obtained by active passage of the fluid flow, preferably by use of a pump, through of one or more particle size pre-selectors arranged before the sampling device.

12. The method according to claim 11, wherein two or more particle size pre-selectors may be coupled in a series, wherein each one separates out a certain particle size fraction of particles to be introduced in a sampling device according to claim 1.

13. The according to claim 1, wherein a denuder device is arranged before the ionization chamber of the sampling device, wherein gas phase components in the fluid flow are collected in the denuder device and the particles in the fluid flow passes through the denuder device to the ionization .

14. The method according to claim 1, wherein the fluid flow is ordinary air, a pure gas or a mixture of gases, a mist, a fog, a smoke, breathing air work environment air, indoor and outdoor air, and cabin air.

15. The method according to claim 1, wherein the particle is an organic and/or inorganic compound as such, asbestos, dust, a metal, an anthrax spore, a bacterium, oil mist components, fungi, pollen, mould, an allergen, preferably an animal allergen, a chemical warfare agent, a biological component, a pathogen, and particles derived from a material which is processed by e.g. welding, cutting or grinding.

16. The method according to claim 1, wherein the gas phase compounds and the gaseous compounds present within and/or on the surface of the particle to be determined are isocyanates, amines, ammonia (NH3), hydrazines, hydrides, mineral acids, benzene, and oxidants.

17. The method according to claim 14, wherein the reagent is specific for the particle, the gas phase compound, and the gaseous compound, which is present within and/or on the surface of the particle, to be determined, wherein said reagent is secondary amine for gas phase isocyanates and particle borne isocyanates; a hydrazine compound for aldehydes and ketones; or an acid for stabilization of biological compounds.

18. The method according to claim 15, wherein the reagent is specific for the particle, the gas phase compound, and the gaseous compound, which is present within and/or on the surface of the particle, to be determined, wherein said reagent is secondary amine for gas phase isocyanates and particle borne isocyanates; a hydrazine compound for aldehydes and ketones; or an acid for stabilization of biological compounds.
